(19) United States
(12) Patent Application Publication
(10) Pub. No.: US 2019/0219185 A1
(43) Pub. Date: Jul. 18, 2019

(54) VACUUM BOOSTER CHECK VALVE

(71) Applicant: ADVICS CO., LTD., Kariya-shi, Aichi-ken (JP)

(72) Inventors: Kenta ISHIKAWA, Nagoya-shi, Aichi-ken (JP); Masaki ARAKAWA, Tajimi-shi, Gifu-ken (JP); Kimiyasu SUZUKI, Gamagori-shi, Aichi-ken (JP)

(73) Assignee: ADVICS CO., LTD., Kariya-shi, Aichi-ken (JP)

(21) Appl. No.: 16/318,570

(22) PCT Filed: Jul. 25, 2017
(86) PCT No.: PCT/JP2017/026818

§ 371 Date: Jan. 17, 2019

(30) Foreign Application Priority Data
Jul. 25, 2016 (JP) 2016-145795
Oct. 31, 2016 (JP) 2016-213870

(51) Int. Cl. F16K 17/04; F16K 15/02; B60T 8/173; F16K 47/02; B60T 13/68; B60T 13/14; B60T 8/176

(52) U.S. Cl. CPC F16K 17/0433; F16K 15/02; B60T 8/173; B60T 8/176; B60T 13/686; B60T 13/145; F16K 47/02

(57) ABSTRACT

A vacuum booster check valve comprises: a main body attached to a vacuum inlet; a first passage, an accommodation section, and a second passage; a valve seat formed in the first passage; a valve body accommodated within the accommodation section; and springs that bias the valve body toward the valve seat. The check valve also comprises vibration absorption sections whereby, when the valve body is seated on the valve seat, one part of the valve body absorbs more vibrations imparted to the valve body compared to other parts of the valve body.

### TECHNICAL FIELD

The present invention relates to a vacuum booster check valve provided between a vacuum booster and a vacuum source.

### BACKGROUND ART

Conventionally, vacuum boosters with respective check valves disclosed in Patent Literature 1 and Patent Literature 2 below are known, for example. The check valve assembled to these conventional vacuum boosters includes a vacuum outlet hole (vacuum outlet port) and a valve seat formed in the vacuum outlet port (vacuum outlet port), in a housing body that houses a valve body working together with the valve seat and a valve spring for seating the valve body on the valve seat. In the check valve disclosed in Patent Literature 1, to suppress vibration of the valve spring and the valve body caused by intermittent intake action of the vacuum source, resonance of the valve spring and the valve body is suppressed by causing the valve spring to have different coil pitches.

### CITATIONS LIST

### Patent Literature

Patent Literature 1: Japanese Unexamined Utility Model Publication No. H6-55915
Patent Literature 2: Japanese Unexamined Patent Publication No H9-202229

### SUMMARY OF INVENTION

### Technical Problem

Unfortunately, the check valve provided between the vacuum source and the vacuum booster may operate such that the entire valve body vibrates due to intermittent intake action (vacuum pulsation) of the vacuum source in a state where the valve body is not completely separated from the valve seat or is seated on the valve seat to cause the valve body to be repeatedly seated on and separated from the valve seat. As described above, when the entire valve body vibrates and the valve body is repeatedly seated on and separated from the valve seat, an abnormal sound (contact sound) may occur due to when the valve body and the valve seat are brought into contact with each other.

The present invention is made to solve the above problem. That is, it is an object of the present invention to provide a vacuum booster check valve that suppresses vibration of the check valve and generation of an abnormal sound (contact sound) caused by vacuum pulsation.

### Solutions to Problem

To solve the above problem, a vacuum booster check valve according to a first aspect of the present invention is provided between a vacuum booster having a vacuum inlet connected to a vacuum source and the vacuum source to block a flow of air from the vacuum source toward the vacuum inlet while allowing a flow of air from the vacuum inlet toward the vacuum source. The vacuum booster check valve includes: a main body provided so as to be connected to a vacuum inlet; a passage formed in the main body to allow the vacuum inlet to communicate with the vacuum source; a valve seat formed in the passage; a valve body having a base portion in a cylindrical shape extending toward inside the passage in an axial direction of the passage while being accommodated in the passage to be seated on or separated from the valve seat, a disk portion extending a radial direction of the base portion, and a protrusion in an annular shape protruding from an outer peripheral portion of the disk portion toward the valve seat; an urging member accommodated in the passage to urge the valve body toward the valve seat so as to bring the protrusion into contact with the valve seat; and a vibration absorption section that absorbs more vibration applied to the valve body in a seated state where the valve body is seated on the valve seat.

### Advantageous Effects of Invention

As a result, when vacuum pulsation occurs in the passage to cause the valve body in a state of being seated on the valve seat to vibrate, the vibration absorption section can absorb more vibration caused by the vacuum pulsation. This enables vibration of the entire valve body to be suppressed. Thus, even when the valve body is repeatedly seated on and separated from the valve seat due to vibration of the valve body caused by vacuum pulsation, vibration of the entire valve body is suppressed, thereby enabling reduction in an abnormal sound (contact sound) caused by when the valve body is brought into contact with the valve seat.

### BRIEF DESCRIPTION OF DRAWINGS

FIG. 1 is a schematic general view of a vacuum booster to which a check valve is assembled according to each embodiment of a vacuum booster check valve of the present invention.

FIG. 2 is a sectional view schematically illustrating structure of a check valve according to a first embodiment of the vacuum booster check valve of the present invention.

FIG. 3a is a view for illustrating a forming portion of grooves (vibration absorption section) constituting the check valve of FIG. 2.

FIG. 3b is a sectional view for illustrating a sectional shape of the grooves taken along line 3b-3b in FIG. 3a.

FIG. 4 is a view for illustrating a suppression effect of contact sound in a check valve having a vibration absorption section.

FIG. 5a is a view for illustrating a forming portion of grooves (vibration absorption section) constituting the check valve of FIG. 2, according to a first modification of the first embodiment.

FIG. 5b is a sectional view for illustrating a sectional shape of the grooves taken along line 5b-5b in FIG. 5a.

FIG. 6a is a sectional view for illustrating structure of a check valve according to a second modification of the first embodiment.

FIG. 6b is a sectional view for illustrating a sectional shape of grooves of FIG. 6a.

FIG. 7a is a sectional view for illustrating structure of a check valve according to the second modification of the first embodiment.

FIG. 7b is a sectional view for illustrating a sectional shape of grooves of FIG. 7a.

FIG. 8 is a view for illustrating a forming portion of grooves (vibration absorption section) constituting a check valve, according to another modification of the first embodiment.

FIG. 9a is a sectional view schematically illustrating structure of a check valve according to a second embodiment of the vacuum booster check valve of the present invention.

FIG. 9b is a view for illustrating a forming portion of a thin portion (vibration absorption section) constituting the check valve of FIG. 9a.

FIG. 10a is a sectional view schematically illustrating structure of a check valve according to a first modification of the second embodiment.

FIG. 10b is a view for illustrating a forming portion of an extending portion (vibration absorption section) constituting the check valve of FIG. 10a.

FIG. 11 is a sectional view schematically illustrating structure of a check valve according to a third embodiment of the vacuum booster check valve of the present invention.

FIG. 12a is a view for illustrating a shape of a valve body constituting the check valve of FIG. 11.

FIG. 12b is a sectional view for illustrating a valve body side plane.

FIG. 13 is a sectional view for illustrating a valve seat side plane according to a first modification of the third embodiment.

FIG. 14 is a sectional view schematically illustrating structure of a check valve according to a fourth embodiment of the vacuum booster check valve of the present invention.

FIG. 15a is a sectional view for illustrating structure of a grommet in FIG. 14.

FIG. 15b is a view for illustrating a forming portion of grooves (vibration absorption section) formed in a peripheral surface of FIG. 15a.

FIG. 16 is a view for illustrating a forming portion of grooves (vibration absorption section) formed in a peripheral surface, according to a first modification of the fourth embodiment.

FIG. 17 is a sectional view for illustrating structure of a flange portion, according to another modification of the fourth embodiment.

### DESCRIPTION OF EMBODIMENTS

Hereinafter, embodiments of the present invention will be described with reference to the accompanying drawings In each of the embodiments and modifications below, the same or equivalent portions are denoted by the same reference numerals in the drawings. In addition, each drawing used for description is a conceptual diagram, and each portion does not necessarily have a strict shape in some cases.

### First Embodiment

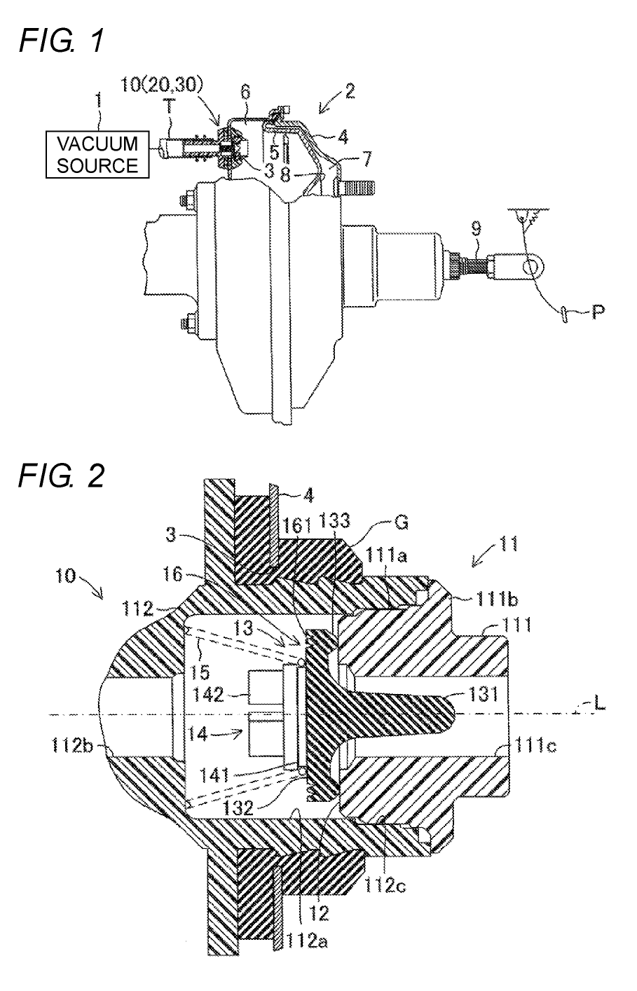

As illustrated in FIG. 1, a vacuum booster check valve 10 (hereinafter simply referred to as a “check valve 10”) is a valve mechanism disposed in a flow channel connecting a vacuum source 1 to a vacuum inlet 3 of a vacuum booster 2. The check valve 10 is configured so as to not only allow flowing of air from a vacuum booster 2 side to a vacuum source 1 side but also block flowing of air from the vacuum source 1 side to the vacuum booster 2 side. The check valve 10 of a first embodiment is connected on its one side to a connection pipe T connected to the vacuum source 1, and on the other side to the vacuum inlet 3 of the vacuum booster 2.

The vacuum source 1 is a manifold of an engine, or the like, and generates a vacuum, for example. The vacuum booster 2 is provided with a shell 4 in a hollow cylindrical shape. The interior of the shell 4 is partitioned into a vacuum chamber 6 and a variable pressure chamber 7 by a partition wall 5. The vacuum chamber 6 is provided with the vacuum inlet 3. As illustrated in FIG. 2, the vacuum inlet 3 is formed in a wall surface of the shell 4 forming the vacuum chamber 6, and is configured to allow the inside and the outside of the vacuum chamber 6 to communicate with each other. Returning to FIG. 1, a booster piston 8 is connected to the partition wall 5. The booster piston 8 is connected to one end of an input rod 9 via a control valve (not illustrated). The input rod 9 is connected at the other end to a brake pedal P.

The vacuum booster 2 is configured such that when the brake pedal P is not depressed, the input rod 9 is retracted together with the brake pedal P. When the control valve (not illustrated) is controlled to allow the variable pressure chamber 7 and the vacuum chamber 6 to have the same pressure, the booster piston 8 also returns to a retracted position. Meanwhile, when the brake pedal P is depressed, the input rod 9 is moved forward together with the brake pedal P. When the control valve (not illustrated) is switched to introduce the atmospheric pressure into the variable pressure chamber 7, the booster piston 8 is urged in its forward direction by a pressure difference (vacuum difference) between the variable pressure chamber 7 and the vacuum chamber 6.

When the atmospheric pressure is introduced into the variable pressure chamber 7 to move the booster piston 8 forward, a part of the air introduced into the variable pressure chamber 7 flows into the vacuum chamber 6, and then the inflowing air flows toward the vacuum source 1 through the check valve 10 and the connection pipe T. That is, the check valve 10 is opened to allow the air to flow from the vacuum chamber 6 to the connection pipe T, so that the air in the vacuum chamber 6 flows toward the vacuum source 1. As a result, the air in the vacuum chamber 6 is sucked by the vacuum source 1 to cause the vacuum chamber 6 to have the same pressure (vacuum) as that of the vacuum source 1. When the pressure of the vacuum source 1 increases more than the pressure of the vacuum chamber 6 with a stop of the engine, for example, the check valve 10 is closed to block an air flow from the connection pipe T to the vacuum chamber 6, thereby maintaining the pressure (vacuum) in the vacuum chamber 6.

As illustrated in FIG. 2, the check valve 10 of the first embodiment is assembled such that the vacuum inlet 3 formed in the shell 4 is airtightly sealed with a grommet G. The check valve 10 includes a main body 11, a valve seat 12, a valve body 13, a retainer 14, and a spring 15.

The main body 11 is composed of a first body part 111 and a second body part 112. The first body part 111 is formed in a cylindrical shape, and includes a projecting portion 111a, a flange portion 111b, and a first passage 111c. The projecting portion 111a is connected to the second body part 112. The flange portion 111b is in contact with the second body part 112. The first passage 111c allows the inside and the outside of the vacuum chamber 6 to communicate with each other.

The second body part 112 is formed in a cylindrical shape and includes an accommodation section 112a with a large diameter, a second passage 112b communicating with the accommodation section 112a, and a fitting portion 112c formed in an opening-side end portion of the accommodation section 112a. The second body part 112 is integrally fixed to the first body part 111 while an inner circumference of the fitting portion 112c is airtightly fitted onto an outer circumference of the projecting portion 111a of the first body part 111. The accommodation section 112a is configured to accommodate the valve seat 12, the valve body 13, the retainer 14, and the spring 15. The second passage 112b communicates with the connection pipe T connected to the vacuum source 1.

The valve seat 12 is formed on a distal end surface of the projecting portion 111a of the first body part 111 accommodated in the accommodation section 112a of the second body part 112. The distal end surface of the projecting portion 111a has a dihedral angle of zero with a plane orthogonal to the axis L of the first passage 111c of the first body part 111 (hereinafter, this plane is referred to as a “reference plane”). That is, the distal end surface of the projecting portion 111a is formed so as to be orthogonal to the axis L of the first passage 111c.

The valve body 13 is composed of a base portion 131, a disk portion 132, and a protrusion 133. In the first embodiment, the base portion 131, the disk portion 132, and the protrusion 133 are integrally formed of a rubber material that is an elastic member. It is preferable that the base portion 131, the disk portion 132, and the protrusion 133 are formed of a rubber material having high rigidity. Specifically, it is preferable to select a rubber material having such rigidity that the valve body 13 is not deformed to be displaced into the first passage 111c when air flows from the vacuum source 1 toward the vacuum chamber 6 while the valve body 13 is seated on the valve seat 12, that is, when the pressure in the second passage 112b is higher than that in the first passage 111c.

The base portion 131 is formed in a solid cylindrical shape so as to extend in the direction of the axis L of the first passage 111c, and its distal end portion enters the first passage 111c of the first body part 111. The disk portion 132 is formed so as to extend in the radial direction of the base portion 131 on a base end side of the base portion 131. The protrusion 133 is annularly formed in an outer peripheral portion of the disk portion 132. The protrusion 133 is formed so as to protrude to face the valve seat 12 while being accommodated in the second body part 112, and is configured to be brought into contact with the valve seat 12 in a seated state where the valve body 13 is seated on the valve seat 12. When the valve body 13 is in the seated state, the protrusion 133 forms a contact surface with the valve seat 12 so as to airtightly seal between the valve body 13 and the valve seat 12.

Here, the protrusion 133 is a contact portion forming a circumferential contact surface, coming into contact with the valve seat 12, in the seated state where the valve body 13 is seated on the valve seat 12, and a plane including a contact portion (or a tip portion of the protrusion 133) before seating (hereinafter this plane is referred to as a “first valve body side plane”) and the reference plane form a dihedral angle of zero. That is, the first valve body side plane and the reference plane are parallel (coincident). This allows the first valve body side plane to be orthogonal to the axis L of the first passage 111c.

Meanwhile, the distal end surface of the projecting portion 111a of the first body part 111 where the valve seat 12 is formed is orthogonal to the axis L of the first passage 111c, as described above. That is, the valve seat 12 is a contact portion forming a circumferential contact surface, coming into contact with the protrusion 133 of the valve body 13, in the seated state where the valve body 13 is seated on the valve seat 12, and a plane including a contact portion (or a circumferential portion formed on a surface of the valve seat 12) before the valve body 13 is seated (hereinafter this plane is referred to as a “first valve seat side plane”) and the reference plane form a dihedral angle of zero. Thus, the first valve seat side plane and the reference plane are parallel (or coincident), and the first valve seat side plane is orthogonal to the axis L of the first passage 111c.

As a result, the first valve body side plane and the reference plane are parallel, and the first valve seat side plane and the reference plane are parallel, in the first embodiment, so that the first valve body side plane and the first valve seat side plane are parallel without inclination. In this case, the protrusion 133 of the valve body 13 is seated on the valve seat 12 such that the contact portion of the protrusion 133 approaches to the contact portion of the valve seat 12 in parallel to allow the protrusion 133 to be seated on the contact portion of the valve seat 12.

The retainer 14 is disposed so as to be brought into contact with the disk portion 132 of the valve body 13. The retainer 14 includes a spring seat 141 having a diameter smaller than an outer diameter of the disk portion 132. The retainer 14 further includes a plurality of columnar legs 142 on a surface of the spring seat 141, facing the second passage 112b. The legs 142 are provided such that the valve body 13 opened does not close second passage 112b when the atmospheric pressure is introduced into the variable pressure chamber 7 of the vacuum booster 2 and a large amount of air flows from the first passage 111c toward the second passage 112b. The legs 142 are each formed of an elastic member (e.g., a rubber material or the like) to prevent an abnormal sound generated when the valve body 13 is opened and comes into contact with an inner surface of the second body part 112.

The spring 15 as the urging member is a coil spring formed in a conical shape. The spring 15 has an end portion with a large diameter that is brought into contact with the inner surface of the second body part 112, and an end portion with a large diameter that is seated on the spring seat 141 of the retainer 14. The spring 15 is configured to urge and press the valve body 13 and the retainer 14 in the direction of the axis L of the first passage 111c. Accordingly, in the seated state where the valve body 13 is seated on the valve seat 12, the protrusion 133 of the valve body 13 is pressed against the contact surface of the valve seat 12 with a pressing force uniform in the circumferential direction by the urging force of the spring 15.

The check valve 10 is provided with a vibration absorption section 16 formed in a part of the disk portion 132 of the valve body 13. The vibration absorption section 16 is formed in a part of the valve body 13 to absorb more vibration than the other part of the valve body 13, thereby suppressing vibration of the entire valve body 13. The vibration absorption section 16 of the first embodiment includes grooves 161 formed in an outer peripheral portion of the disk portion 132 along its circumferential direction.

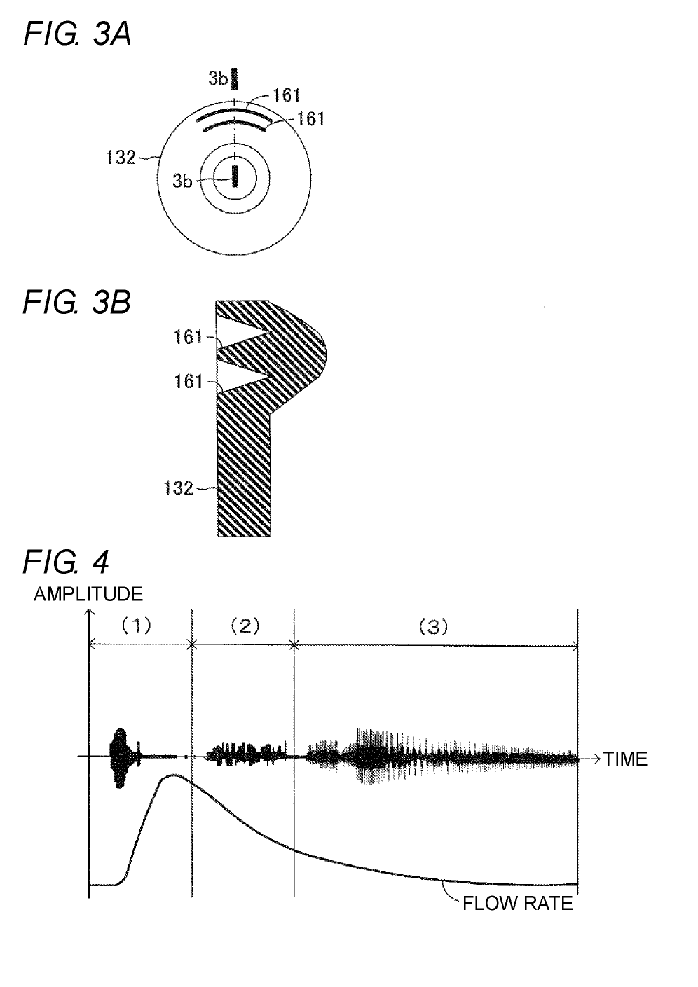

As illustrated in FIGS. 2 and 3a, the grooves 161 are formed in a part of the disk portion 132, specifically, in a portion in the vicinity of the outer peripheral end in the circumferential direction. The grooves 161 are each formed so as to open toward the spring 15, and have a cross-sectional shape of a V-shape, as illustrated in FIGS. 2 and 3b. As described above, the disk portion 132 provided with the grooves 161 formed in the vicinity of the outer peripheral end includes a portion with the grooves 161 (hereinafter referred to as “a part of the disk portion 132”) and a portion without the grooves 161 (hereinafter referred to as “the other part of the disk portion 132”) that are different in rigidity. Specifically, the part of the disk portion 132 has rigidity smaller (softer) than that of the other part of the disk portion 132. While the two grooves 161 are formed in the first embodiment, the number of the grooves 161 formed is not limited to this, and it is needless to say that the number of the grooves 161 can be increased or reduced as necessary.

When the part of the disk portion 132 has low rigidity, the part of the disk portion 132 easily vibrates. As a result, in a situation where the valve body 13 vibrates when the valve body 13 is seated, the part of the disk portion 132 vibrates prior to the other part of the disk portion 132. As described above, when the part of the disk portion 132 vibrates prior to the other part of the disk portion 132, vibration energy given from air to the valve body 13 (the disk portion 132) can be consumed. This enables vibration of the entire valve body 13 (disk portion 132) to be suppressed.

While the protrusion 133 formed close to the part of the disk portion 132 tends to easily separate from the valve seat 12, an impact load when the protrusion 133 is brought into contact with the valve seat 12 to be seated again can be reduced due to the low rigidity of the part of the disk portion 132. As a result, even when the part of the disk portion 132, or the vibration absorption section 16, vibrates, the contact sound can be reduced. When the part of the disk portion 132 vibrates prior to the other part of the disk portion 132, vibration of the entire valve body 13 can be suppressed. This enables suppressing transfer of a large impact load to the valve seat 12 due to vibration of the other part of the disk portion 132 with high rigidity, so that an occurrence of the contact sound can be suppressed.

Next, operation of the check valve 10 configured as described above will be described. There are described the following operations in order: (1) operation immediately after operation of depressing the brake pedal P starts; (2) operation when there is a large pressure difference (vacuum difference) between the vacuum chamber 6 and the vacuum source 1; and (3) operation when there is a small pressure difference (vacuum difference) between the vacuum chamber 6 and the vacuum source 1.

First, the check valve 10 is configured as described above such that when the brake pedal P is depressed, the atmospheric pressure is introduced into the variable pressure chamber 7 and air flows into the vacuum chamber 6 to allow air in the vacuum chamber 6 to flow into the first passage 111c of the main body 11. As a result, when the pressure of the vacuum chamber 6 increases more than the urging force of the spring 15, the valve body 13 is separated from the valve seat 12. This allows air to flow from the vacuum chamber 6 toward the vacuum source 1 through the vacuum inlet 3, or air to flow the first passage 111c toward the second passage 112b.

(1) Operation Immediately after Operation of Depressing the Brake Pedal P Starts

Immediately after operation of depressing the brake pedal P starts, a pressure difference (vacuum difference) between the vacuum chamber 6 and the vacuum source 1 rapidly increases from a state with a small pressure difference (vacuum difference) therebetween, so that a pressure difference (vacuum difference) between the first passage 111c and the second passage 112b also rapidly increases from a state with a small pressure difference therebetween. In addition, immediately after operation of depressing the brake pedal P starts, a flow rate of air flowing from the vacuum chamber 6 to the vacuum source 1 through the vacuum inlet 3 increases, so that a flow rate of air flowing from the first passage 111c to the second passage 112b also increases, as illustrated in FIG. 4.

As a result, when the valve body 13 is separated from the valve seat 12 immediately after operation of depressing the brake pedal P starts, the valve body 13 is displaced toward the second passage 112b against the urging force (pressing force) of the spring 15. This causes the legs 142 of the retainer 14 to be brought into contact with the inner surface of the second body part 112. Even when the legs 142 are brought into contact with the inner surface of the second body part 112, a shock caused by the contact as described above is reduced to suppress an occurrence of an abnormal sound and the like due to the legs 142 each made of a rubber material.

(2) Operation when there is a Large Pressure Difference (Vacuum Difference) Between the Vacuum Chamber 6 and the Vacuum Source 1

As time elapses after operation of depressing the brake pedal P starts, a pressure difference (vacuum difference) between the vacuum chamber 6 and the vacuum source 1 gradually decreases because the vacuum source 1 sucks air. Accordingly, a pressure difference (vacuum difference) between the first passage 111c and the second passage 112b also gradually decreases. When the pressure difference (vacuum difference) between the first passage 111c and the second passage 112b gradually decreases as described above, the valve body 13 is gradually displaced toward a first passage 111c side from a second passage 112b side, or in the direction of seating on the valve seat 12, by the urging force of the spring 15.

Even when the valve body 13 is displaced in the direction of seating on the valve seat 12, air flows toward the vacuum source 1 from the vacuum chamber 6 through the vacuum inlet 3 as illustrated in FIG. 4. Depending on a cycle of sucking air with the vacuum source 1 (e.g., a manifold of an engine, or the like), a balance between magnitude of pressure acting on the valve body 13 from flowing air, and magnitude of an urging force acting on the valve body 13 from the spring 15, may be lost. In this case, the valve body 13 and the spring 15 vibrate together (resonate), so that the legs 142 of the retainer 14 may be brought into contact with the inner surface of the second body part 112, for example. Even when the legs 142 are brought into contact with the inner surface of the second body part 112, a shock caused by the contact as described above is also reduced to suppress occurrence of an abnormal sound and the like due to the legs 142 each made of a rubber material.

(3) Operation when there is a Small Pressure Difference (Vacuum Difference) Between the Vacuum Chamber 6 and the Vacuum Source 1

As time elapses after operation of depressing the brake pedal P starts, a pressure difference (vacuum difference) between the vacuum chamber 6 and the vacuum source 1 more decreases as illustrated in FIG. 4 because the vacuum source 1 continuously sucks air. In this case, a pressure difference (vacuum difference) between the first passage 111c and the second passage 112b also more decreases. When the pressure difference (vacuum difference) between the first passage 111c and the second passage 112b more decreases as described above, the urging force of the spring 15 causes the valve body 13 to be brought into the seated state. As a result, the check valve 10 blocks a flow of air from the vacuum chamber 6 to the vacuum source 1 through the vacuum inlet 3, or a flow of air from the first passage 111c to the second passage 112b.

Even in the seated state, the vacuum source 1 continues to suck the air existing in the second passage 112b. At this time, vacuum pulsation (e.g., air resonance) may occur in the second passage 112b connected to the connection pipe T depending on a cycle of sucking air with the vacuum source 1. The vacuum pulsation generated as described above acts so as to excite vibration to the valve body 13 in the seated state.

The valve body 13 is provided with the vibration absorption section 16 formed in a part of the disk portion 132. Specifically, the vibration absorption section 16 includes the grooves 161 formed in a part of the disk portion 132. When the entire valve body 13 is about to vibrate by being excited by vacuum pulsation, the vibration absorption section 16 including the part of the disk portion 132 having low rigidity starts vibrating prior to the other part of the disk portion 132. When the vibration absorption section 16 starts vibrating earlier as described above, there is consumed vibration energy for vibrating the entire valve body 13 given from air by vacuum pulsation. As a result, the entire valve body 13 vibrates to enable the entire valve body 13 to be prevented from being repeatedly seated on and separated from the valve seat 12.

In this case, an impact load applied to the valve seat 12 by the protrusion 133 at the time of seating is reduced due to the vibration absorption section 16 having the low rigidity even when the protrusion 133 close to the vibration absorption section 16 is repeatedly separated from and seated on the valve seat 12 in accordance with the vibration of the vibration absorption section 16. This enables suppressing a large impact load to be applied to the valve seat 12 due to the vibration of the protrusion 133 close to the other part of the rigid disk portion 132, so that magnitude of a contact sound can be suppressed as illustrated by the solid line in FIG. 4. When the vibration absorption section 16 vibrates, a generated contact sound is reduced due to a small impact load. In FIG. 4, the waveform indicated by the alternate long and short dashed line represents magnitude (amplitude) of a contact sound in a check valve without the vibration absorption section 16.

In addition, when the entire valve body 13 vibrates, the vibration of the valve body 13 also propagates to the spring 15, and then the spring 15 may bend. This may cause the vibration of the valve body 13 and the vibration of the spring 15 to resonate, so that the protrusion 133 of the valve body 13 may apply a large impact load to the valve seat 12. However, the vibration absorption section 16 vibrates earlier to enable suppressing vibration of the entire valve body 13, so that bending of the spring 15 can be suppressed. That is, the vibration absorption section 16 can also suppress an occurrence of vibration of the spring 15 (urging member) caused by vacuum pulsation. This also enables reducing an impact load applied to the valve seat 12 by the valve body 13, so that an occurrence of a contact sound caused by the vacuum pulsation can be suppressed.

Even when the spring 15 vibrates prior to the valve body 13 due to vacuum pulsation to cause the vibration to be transmitted to the valve body 13, the vibration absorption section 16 vibrates earlier to enable suppressing vibration of the entire valve body 13. This suppresses the vibration of the entire valve body 13 and the spring 15, so that an occurrence of a contact sound due to the vacuum pulsation can be suppressed.

Even when an amount of depression is small at the start of the operation of depressing the brake pedal P, the valve body 13 may vibrate due to vacuum pulsation. The vibration absorption section 16 can suppress vibration of the entire valve body 13 even for vibration as described above, so that an occurrence of a contact sound caused by the vacuum pulsation can be suppressed.

When operation of the vacuum source 1 stops in the seated state of the valve body 13, pressure on the vacuum source 1 side may increase more than pressure on a vacuum chamber 6 side. In this case, pressure on the second passage 112b side also increases more than pressure on the first passage 111c side, so that the valve body 13 is not only pressed with pressure transmitted from the second passage 112b side in addition to the urging force of the spring 15, but also sucked by the vacuum of the vacuum chamber 6 communicating with the first passage 111c. Then, in the valve body 13, the base portion 131 accommodated in the first passage 111c is about to be displaced toward the vacuum chamber 6. As a result, the disk portion 132 extending radially from the base portion 131 is deformed so as to be reduced in diameter due to a difference between the inner diameter of the valve seat 12 and the outer diameter of the disk portion 132 in accordance with the displacement of the base portion 131 toward the vacuum chamber 6. At this time, the rubber material forming the disk portion 132 flows internally in the direction of the grooves 161, and is about to close an opening of each of the grooves 161. When the opening of each of the grooves 161 is closed, the part of the disk portion 132 increases in rigidity. This causes the entire disk portion 132 to increase in rigidity. As the disk portion 132 increases in rigidity, resistance when the disk portion 132 passes through the inner diameter of the valve seat 12 increases. This resistance restricts displacement of the valve body 13 toward the vacuum chamber 6, so that the valve body 13 can continue to be seated on the valve seat 12. This enables sealing properties for sealing the vacuum chamber 6 to be secured sufficiently.

As can be understood from the above description, the vacuum booster check valve 10 according to the first embodiment is provided between the vacuum booster 2 having the vacuum inlet 3 connected to the vacuum source 1 and the vacuum source 1 to block a flow of air from the vacuum source 1 toward the vacuum inlet 3 while allowing a flow of air from the vacuum inlet 3 toward the vacuum source 1. The vacuum booster check valve 10 can be configured to include: the main body 11 provided so as to be connected to the vacuum inlet 3; the first passage 111c allowing the vacuum inlet 3 to communicate with the vacuum source 1, the accommodation section 112a, and the second passage 112b, being formed in the main body 11; the valve seat 12 formed in the first passage 111c; the valve body 13 having the base portion 131 in a cylindrical shape extending toward inside the first passage 111c in the direction of the axis L of the first passage 111c while being accommodated in the accommodation section 112a to be seated on or separated from the valve seat 12, the disk portion 132 extending in the radial direction of the base portion 131, and the protrusion 133 in an annular shape protruding from the outer peripheral portion of the disk portion 132 toward the valve seat 12; the spring 15 accommodated in the accommodation section 112a to urge the valve body 13 toward the valve seat 12 so as to bring the protrusion 133 into contact with the valve seat 12; and the vibration absorption section 16 that absorbs more vibration applied to the valve body 13 in the part of the valve body 13 than the other part of the valve body 13 in the seated state where the valve body 13 is seated on the valve seat 12.

Accordingly, when the valve body 13 vibrates due to vacuum pulsation occurring in the accommodation section 112a and the second passage 112b in the seated state of the valve body 13, the vibration absorption section 16 formed in the part of the valve body 13 (specifically, the disk portion 132) can absorb more vibration caused by the vacuum pulsation than the other part of the valve body 13 (specifically, the disk portion 132). This enables vibration of the entire valve body 13 to be suppressed. Thus, even when the valve body 13 is repeatedly seated on and separated from the valve seat 12 due to vibration of the valve body 13 caused by vacuum pulsation, vibration of the entire valve body 13 is suppressed, thereby enabling reduction in a contact sound caused by when the valve body 13 (specifically, the protrusion 133) is brought into contact with the valve seat 12.

In addition, the vibration absorption section 16 suppresses vibration of the entire valve body 13, so that vibration to be transmitted from the valve body 13 to the spring 15 can also be reduced. This enables bending of the spring 15 to be reduced, so that resonance of the valve body 13 and the spring 15 can be suppressed. As a result, vibration of the valve body 13 due to the resonance with the spring 15 can be suppressed to enable reducing a contact sound generated when the valve body 13 (specifically, the protrusion 133) is brought into contact with the valve seat 12.

In this case, the valve body 13 can be configured as follows: at least the disk portion 132 and the protrusion 133 are each formed of an elastic material; the vibration absorption section 16 is formed in a part of the disk portion 132 of the valve body 13; and the part of the disk portion 132 has rigidity smaller than rigidity of the other part of the disk portion 132 of the valve body 13.

Accordingly, the part of the disk portion 132 can be reduced in rigidity, so that the part of the disk portion 132 easily vibrates. This enables the part of the disk portion 132 to vibrate prior to the other part of the disk portion 132. At this time, while the protrusion 133 formed close to the part of the disk portion 132 tends to easily separate from the valve seat 12, an impact load when the protrusion 133 is brought into contact with the valve seat 12 to be seated again can be reduced due to the low rigidity of the part of the disk portion 132. In addition, when the part of the disk portion 132 vibrates prior to the other part of the disk portion 132, the valve body 13 is prevented from vibrating as a whole. This prevents the other part of the disk portion 132 having high rigidity from vibrating, so that transmission of a large impact load to the valve seat 12 can be suppressed. This enables suppressing an occurrence of a contact sound.

In this case, the part of the disk portion 132 can include the grooves 161 formed in the disk portion 132 so as to open toward the spring 15 in the circumferential direction that is one of the circumferential direction and the radial direction of the disk portion 132.

Accordingly, forming the grooves 161 in the disk portion 132 enables reduction in rigidity of the part of the disk portion 132. This enables the part of the disk portion 132 to be reduced in rigidity very easily, so that an occurrence of a contact sound can be suppressed. In addition, in a state where the valve body 13 is displaced to a vacuum inlet 3 side in the seated state of the valve body 13, closing the opening of each of the grooves 161 enables increase in rigidity of the valve body 13 (specifically, the disk portion 132). Accordingly, there is no need to provide a backup ring or the like for restricting displacement of the valve body 13 toward the vacuum inlet 3, for example, so that manufacturing costs can be reduced.

### <First Modification of First Embodiment>

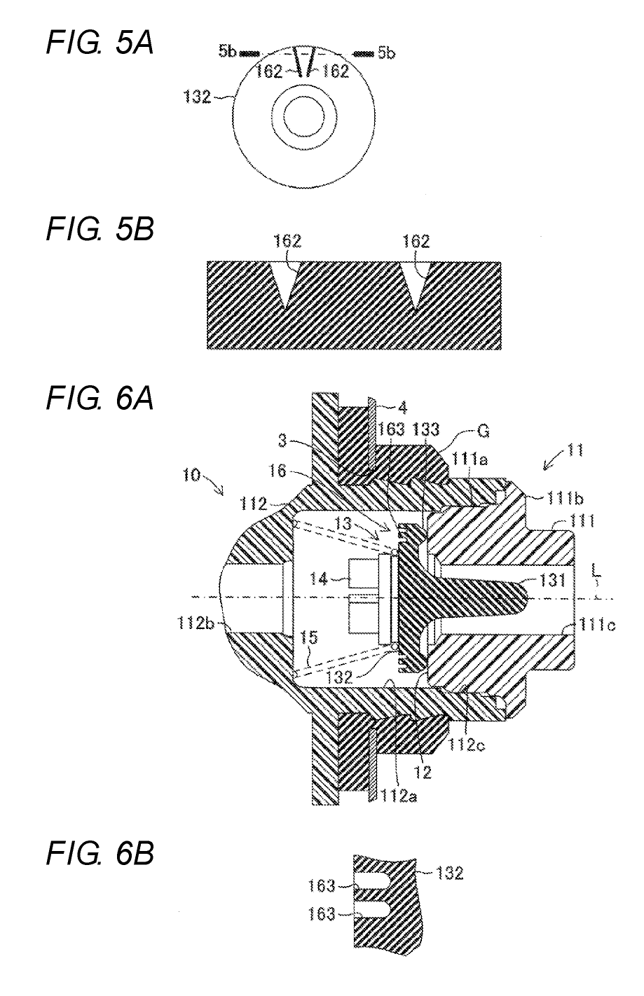

In the first embodiment, the grooves 161 are formed in a part of the outer peripheral portion of the disk portion 132 in its circumferential direction. In this case, instead of or in addition to forming the grooves 161 in the part in the circumferential direction, grooves 162 extending in the radial direction that is one of the circumferential direction and the radial direction of the disk portion 132 can also be formed, as illustrated in FIG. 5. Thus, the vibration absorption section 16 in this first modification includes the grooves 162 formed in the radial direction of the disk portion 132.

As illustrated in FIG. 5a, the grooves 162 are formed radially in the part of the disk portion 132, specifically, in the outer peripheral portion of the disk portion 132. The grooves 162 are each formed so as to open toward the spring 15, and have a cross-sectional shape of a V-shape as illustrated in FIG. 5b in an enlarged manner. In the disk portion 132 in which the grooves 162 are formed radially as described above, rigidity of the part of the disk portion 132 with the grooves 162 is different from that of the other part of the disk portion 132 provided without the grooves 162. Specifically, the part of the disk portion 132 has rigidity smaller (softer) than that of the other part of the disk portion 132.

Thus, even when the grooves 162 are formed radially in the outer peripheral portion of the disk portion 132 and the vibration absorption section 16 is formed so as to include the grooves 162, the part of the disk portion 132 can be reduced in rigidity very easily to enable suppressing an occurrence of a contact sound. In addition, in a state where the valve body 13 is displaced to a vacuum inlet 3 side in the seated state of the valve body 13, closing the opening of each of the grooves 162 enables increase in rigidity of the valve body 13 (specifically, the disk portion 132). Accordingly, there is no need to provide a backup ring or the like for restricting displacement of the valve body 13 toward the vacuum inlet 3, for example, so that manufacturing costs can be reduced.

### <Second Modification of First Embodiment>

In the first embodiment, the grooves 161 each formed in the disk portion 132 in its circumferential direction has a cross-sectional shape of a V-shape. In the first modification, the grooves 162 each radially formed in the disk portion 132 has a cross-sectional shape of a V-shape. Instead of the cross-sectional shape of a V-shape of each of the grooves 161 and 162, the grooves 161 and 162 formed in the outer peripheral portion of the disk portion 132 in its circumferential direction and/or radial direction may each have a cross-sectional shape of a U-shape as illustrated in each of FIGS. 6a and 6b. This case also enables a part of the disk portion 132 to be reduced in rigidity, and the entire disk portion 132 to be increased in rigidity by closing an opening of each of the grooves, as in the first embodiment.

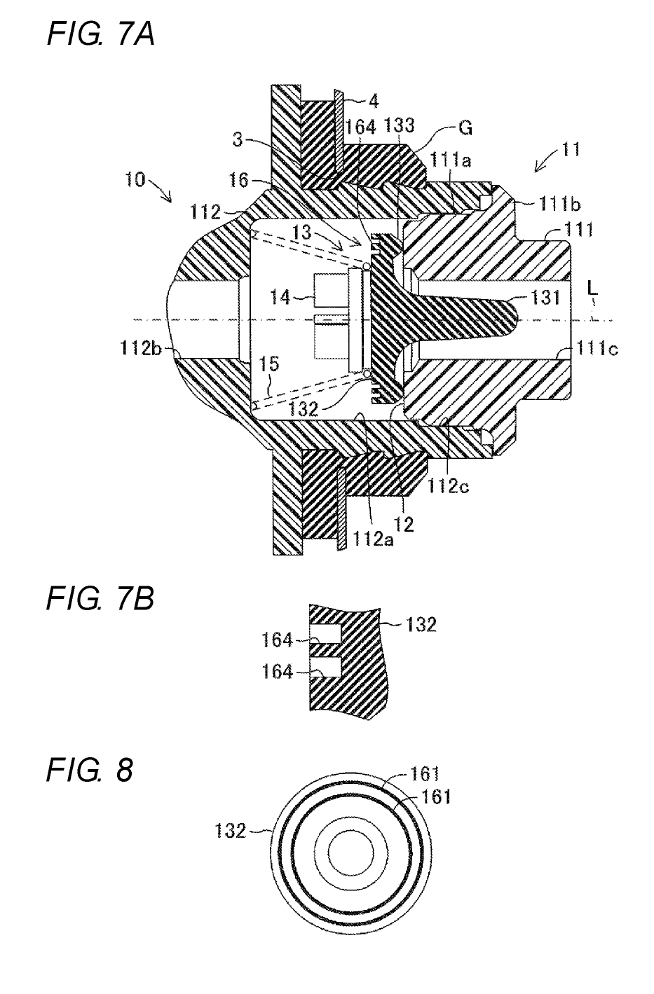

Instead of the cross-sectional shape of a V-shape of each of the grooves 161 and 162, the grooves 161 and 162 formed in the outer peripheral the disk portion 132 in its circumferential direction and/or radial direction may each have a cross-sectional shape of a rectangular shape as illustrated in each of FIGS. 7a and 7b. This case also enables a part of the disk portion 132 to be reduced in rigidity, and the entire disk portion 132 to be increased in rigidity by closing an opening of each of the grooves, as in the first embodiment.

### <Another Modification of First Embodiment>

In the first embodiment, the grooves 161 are formed in the vicinity of the outer peripheral end of the disk portion 132 in the circumferential direction. In this case, the grooves 161 may be formed in the vicinity of the outer peripheral end of the disk portion 132 all around in the circumferential direction as illustrated in FIG. 8. Even when the grooves 161 are each formed all around the disk portion 132 as described above, the vicinity of the outer peripheral end, being a part of the disk portion 132, has rigidity smaller than rigidity of the other part of the disk portion 132. This enables an effect equivalent to that in the first embodiment to be obtained.

### Second Embodiment

In the first embodiment, the check valve 10 is configured to include the valve body 13 in which the base portion 131, the disk portion 132, and the protrusion 133 are integrally formed of a rubber material that is an elastic material. This case can be also configured as follows: the disk portion 132 and the protrusion 133 are integrally formed of a rubber material that is an elastic material; the base portion 131 is integrally formed with the retainer 14; and the retainer 14 is eliminated. That is, the second embodiment is different from the check valve 10 of the first embodiment in that a check valve 20 includes a valve body 23 in which a disk portion 132 and a protrusion 133 are integrally formed and a base portion 131 is integrally formed with a retainer 14.

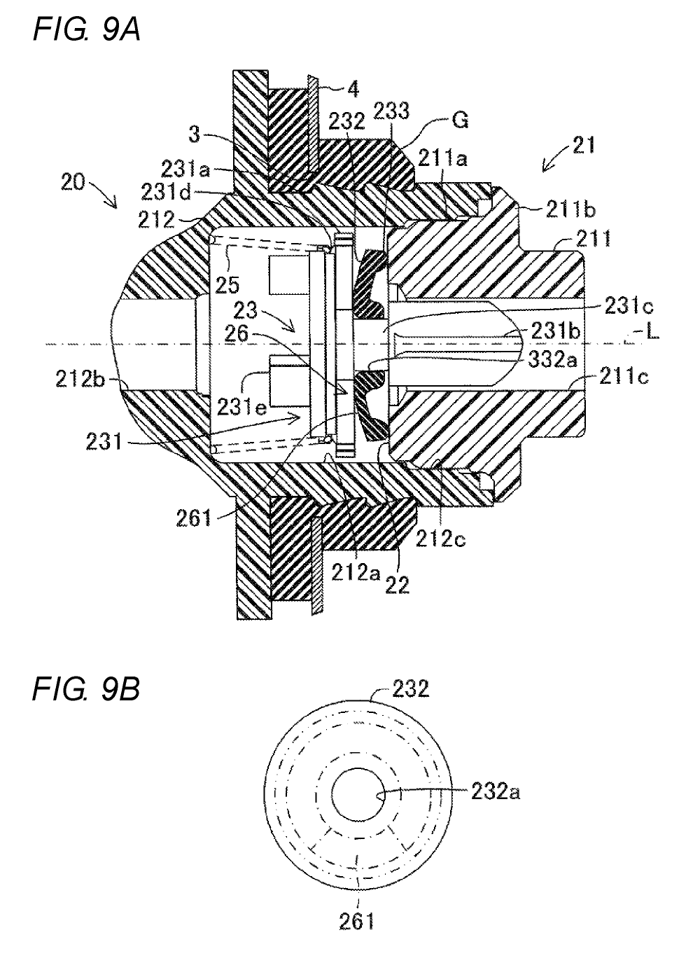

As illustrated in FIG. 9a, the check valve 20 of the second embodiment is assembled such that a vacuum inlet 3 formed in a shell 4 is airtightly sealed with a grommet G. The check valve 20 includes a main body 21, a valve seat 22, a valve body 23, and a spring 25. The main body 21 is composed of a first body part 211 and a second body part 212.

The first body part 211 and the second body part 212 correspond to the first body part 111 and the second body part 112 constituting the main body 11 of the first embodiment, respectively, and are configured to be the same as the corresponding ones. Specifically, a projecting portion 211a, a flange portion 211b, and a first passage 211c of the first body part 211 correspond to the projecting portion 111a, the flange portion 111b, and the first passage 111c of the first body part 111 of the first embodiment, respectively, and are configured to be the same as the corresponding ones. In addition, an accommodation section 212a, a second passage 212b, and a fitting portion 212c of the second body part 212 correspond to the accommodation section 112a, the second passage 112b, and the fitting portion 112c of the second body part 112 of the first embodiment, respectively, and are configured to be the same as the corresponding ones. Further, the valve seat 22 and the spring 25 correspond to the valve seat 12 and the spring 15 of the first embodiment, respectively, and are configured to be the same as the corresponding ones.

The valve body 23 of the second embodiment is composed of a base portion 231, a disk part 232, and a protrusion 233. The disk part 232 and the protrusion 233 are integrally formed of the same elastic material, or the same rubber material, for example.

The base portion 231 includes a large diameter portion 231a accommodated in the accommodation section 212a of the second body part 212, a small diameter portion 231b inserted into the first passage 211c of the first body part 211, and a neck portion 231c in a columnar shape formed between the large diameter portion 231a and the small diameter portion 231b. The large diameter portion 231a, the small diameter portion 231b, and the neck portion 231c are disposed coaxially with an axis L of the first passage 211c. The large diameter portion 231a of the base portion 231 is provided in its surface opposite to its surface connected to the neck portion 231c with a spring seat 231d on which an end portion with a small diameter of the spring 25 is seated, and a plurality of legs 231e each in a cylindrical shape. The legs 231e are each formed of a rubber material.

The disk part 232 is a disk having a larger diameter than the first passage 211c of the first body part 211, and is provided in its central portion with a through hole 232a into which the neck portion 231c of the base portion 231 is airtightly inserted, as illustrated in FIG. 9b. In addition, the disk part 232 is formed in an umbrella shape with an apex at a forming position of the through hole 232a, and is provided in its outer peripheral portion integrally with the protrusion 233. The protrusion 233 is formed so as to protrude to face the valve seat 22 while being accommodated in the second body part 212, and is configured to be brought into contact with the valve seat 22 in a seated state where the valve body 23 is seated on the valve seat 22. The protrusion 233 is configured to form a contact surface with the valve seat 22 to airtightly seal between the valve body 23 and the valve seat 22 in the seated state of the valve body 23.

Here, the valve seat 22 is a contact portion forming a circumferential contact surface, coming into contact with the valve body 23, in the seated state where the valve body 23 is seated on the valve seat 22, and a plane including a contact portion (or a circumferential portion formed on a surface of the valve seat 22) before the valve body 23 is seated (hereinafter this plane is referred to as a “second valve seat side plane”) and a reference plane form a dihedral angle of zero. Thus, the second valve seat side plane and the reference plane above are parallel (or coincident), and the second valve seat side plane is orthogonal to the axis L of the first passage 211c.

In addition, the protrusion 233 is a contact portion forming a circumferential contact surface, coming into contact with the valve seat 22, in the seated state where the valve body 23 is seated on the valve seat 22, and a plane including a contact portion (or a tip portion of the protrusion 233 in its seating direction) before seating (hereinafter this plane is referred to as a “second valve body side plane”) and the reference plane form a dihedral angle of zero. Thus, the second valve seat side plane and the reference plane are parallel (or coincident), and the second valve seat side plane and the second valve body side plane are parallel, in the second embodiment. In this case, when the protrusion 233 of the valve body 23 is seated on the valve seat 22, the contact portion of the protrusion 233 approaches to the contact portion of the valve seat 22 in parallel to allow the protrusion 233 to be seated on the contact portion of the valve seat 22.

The check valve 20 in the second embodiment is provided with a vibration absorption section 26 formed in a part of the disk part 232 of the valve body 23. As with the vibration absorption section 16 of the first embodiment, the vibration absorption section 26 in the second embodiment is configured to suppress vibration of the entire valve body 23 by vibrating a part of the disk part 232 to consume vibration energy applied to the valve body 23 (disk part 232) from air.

The vibration absorption section 26 of the second embodiment includes a thin portion 261 formed so as to decrease in thickness in the circumferential direction of the disk part 232. As illustrated in FIG. 9b, the thin portion 261 is formed in a part of the disk part 232, more specifically, in a part in the circumferential direction of the disk part 232, being radially outside the through hole 232a and radially inside the protrusion 233. As described above, the disk part 232 provided with the thin portion 261 is formed of the same elastic material as a whole, so that a portion with the thin portion 261 (hereinafter referred to as “a part of the disk part 232”) and a portion provided without thin portion 261 (hereinafter referred to as “the other part of the disk part 232”) are different in rigidity. Specifically, the part of the disk part 232 has rigidity smaller (softer) than that of the other part of the disk part 232.

The check valve 20 of the second embodiment including the valve body 23 configured as described above also operates similarly as the operations described above: “(1) operation immediately after operation of depressing the brake pedal P starts”; “(2) operation when there is a large pressure difference (vacuum difference) between the vacuum chamber 6 and the vacuum source 1”; and “(3) operation when there is a small pressure difference (vacuum difference) between the vacuum chamber 6 and the vacuum source 1”. In the “(1) operation immediately after operation of depressing the brake pedal P starts” and the “(2) operation when there is a large pressure difference (vacuum difference) between the vacuum chamber 6 and the vacuum source 1”, the valve body 23 of the check valve 20 operates identically with the valve body 13 of the check valve 10. Thus, in the description above, the “valve body 13”, “disk portion 132”, “protrusion 133”, “leg 142”, and “spring 15” are substituted with the “valve body 23”, “disk part 232”, “protrusion 233”, “leg 231e”, and “spring 25”, respectively, to eliminate description thereof

(3) Operation when there is a Small Pressure Difference (Vacuum Difference) Between the Vacuum Chamber 6 and the Vacuum Source 1

As time elapses after operation of depressing the brake pedal P, a pressure difference (vacuum difference) between the vacuum chamber 6 and the vacuum source 1 decreases because the vacuum source 1 sucks air. In this case, a pressure difference (vacuum difference) between the first passage 211c and the second passage 212b also decreases. When the pressure difference (vacuum difference) between the first passage 211c and the second passage 212b decreases as described above, the urging force of the spring 25 causes the valve body 23 to be brought into a state seated on the valve seat 22 (seated state).

Even in the state where the valve body 23 is seated on the valve seat 22 as described above, the vacuum source 1 continues to suck the air existing in the second passage 212b. At this time, vacuum pulsation (e.g., air resonance) may occur in the second passage 212b connected to the connection pipe T depending on a cycle of sucking air with the vacuum source 1. The vacuum pulsation generated as described above acts so as to excite vibration to the valve body 23 in the seated state.

The valve body 23 is provided with the vibration absorption section 26 formed in a part of the disk part 232. Specifically, the vibration absorption section 26 includes the thin portion 261 formed in a part of the disk part 232. When the entire valve body 23 is about to vibrate by being excited by vacuum pulsation, the vibration absorption section 26 including the part of the disk part 232 having low rigidity starts vibrating prior to the other part of the disk part 232. When the vibration absorption section 26 starts vibrating earlier as described above, there is consumed vibration energy for vibrating the entire valve body 23 given from air by vacuum pulsation. As a result, the entire valve body 23 vibrates to enable the entire valve body 23 to be prevented from being repeatedly seated on and separated from the valve seat 22.

In this case, an impact load applied to the valve seat 22 by the protrusion 233 at the time of seating is reduced due to the vibration absorption section 26 having the low rigidity even when the protrusion 233 close to the vibration absorption section 26 is repeatedly separated from and seated on the valve seat 22 in accordance with the vibration of the vibration absorption section 26. This enables suppressing a large impact load to be applied to the valve seat 22 due to the vibration of the protrusion 233 close to the other part of the rigid disk part 232, so that a contact sound can be suppressed as illustrated by the solid line in FIG. 4. When the vibration absorption section 26 vibrates, a generated contact sound is reduced due to a small impact load.

In addition, when the entire valve body 23 vibrates, the vibration of the valve body 23 also propagates to the spring 25, and then the spring 25 may bend. This may cause the vibration of the valve body 23 and the vibration of the spring 25 to resonate, so that the protrusion 233 of the valve body 23 may apply a large impact load to the valve seat 22. However, the vibration absorption section 26 vibrates earlier to enable suppressing vibration of the entire valve body 23, so that bending of the spring 25 can be suppressed. That is, the vibration absorption section 26 can also suppress an occurrence of vibration of the spring 15 caused by vacuum pulsation. This also enables reducing an impact load applied to the valve seat 22 by the valve body 23, so that an occurrence of a contact sound caused by the vacuum pulsation can be suppressed.

Even when the spring 25 vibrates prior to the valve body 23 due to vacuum pulsation to cause the vibration to be transmitted to the valve body 23, the vibration absorption section 26 vibrates earlier to enable suppressing vibration of the entire valve body 23. This enables suppressing an occurrence of a contact sound caused by vacuum pulsation.

As can be understood from the above description, the second embodiment enables a part of the disk part 232 and the other part of the disk part 232 to be formed of the same rubber material, and the part of the disk part 232 to have a thickness less than that of the other part of the disk part 232.

Accordingly, the part of the disk part 232 can be reduced in rigidity, so that the part of the disk part 232 easily vibrates. This enables the part of the disk part 232 to vibrate prior to the other part of the disk part 232. At this time, while the protrusion 233 formed close to the part of the disk part 232 tends to easily separate from the valve seat 12, an impact load when the protrusion 233 is brought into contact with the valve seat 12 to be seated again can be reduced due to the low rigidity of the part of the disk portion 132. In addition, when the part of the disk part 232 vibrates prior to the other part of the disk part 232, the valve body 23 is prevented from vibrating as a whole. This prevents the other part of the disk part 232 having high rigidity from vibrating, so that transmission of a large impact load to the valve seat 22 can be suppressed. This enables suppressing an occurrence of a contact sound.

In addition, forming the thin portion 261 in the disk part 232 enables reduction in rigidity of the part of the disk part 232. This enables the part of the disk part 232 to be reduced in rigidity very easily, so that an occurrence of a contact sound can be suppressed.

### <First Modification of Second Embodiment>

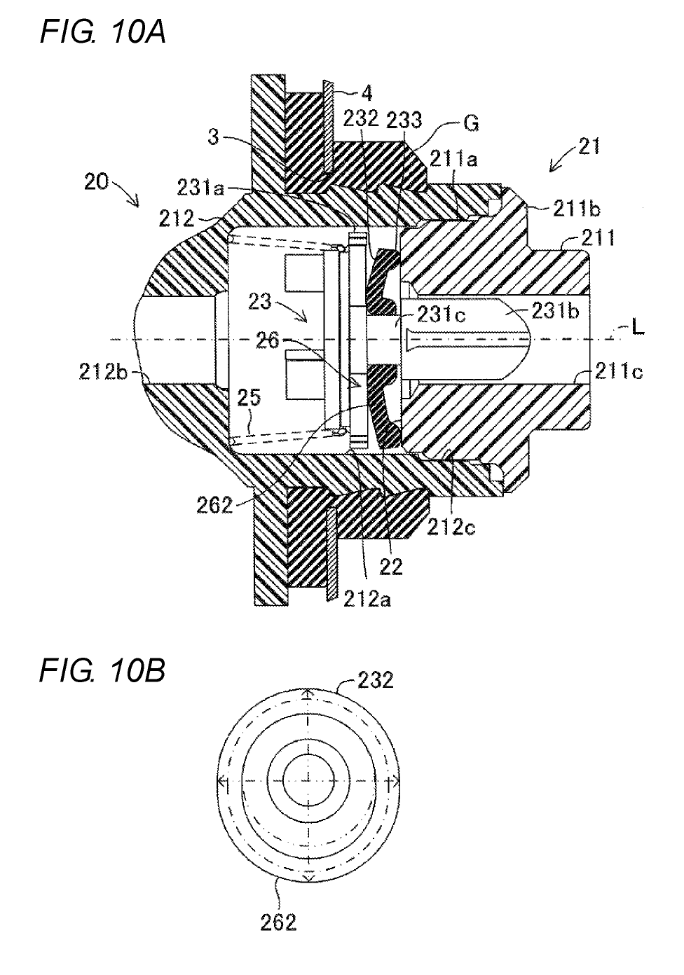

In the second embodiment, the thin portion 261 is formed in a part of the disk part 232. Instead of or in addition to forming the thin portion 261 as described above, an extending portion 262 can also be formed in the disk part 232 as illustrated in FIGS. 10a and 10b. Thus, the vibration absorption section 26 in this first modification includes the extending portion 262 formed in the disk part 232.

In this first modification, the disk part 232 is formed so as to have a major axis and a minor axis as illustrated in FIG. 10b, and a portion extending in a direction of the major axis of the disk part 232 serves as the extending portion 262. The disk part 232 is formed so as to have the same thickness over the entire disk part 232. Even when the extending portion 262 is formed in the disk part 232 as described above, an outer peripheral portion of the disk part 232 on its major diameter side is not brought into contact with an inner peripheral surface of the accommodation section 212a of the second body part 212 as illustrated in FIG. 10a.

In the disk part 232 in which the extending portion 262 is formed as described above, rigidity of the part of the disk part 232 with the extending portion 262 is different from that of the other part of the disk part 232 without the extending portion 262. Specifically, the part of the disk part 232 has rigidity smaller (softer) than that of the other part of the disk part 232.

Thus, even when the disk part 232 has the major axis and the minor axis, and the vibration absorption section 26 is formed in a part of the disk part 232 so as to include the extending portion 262 formed in the disk part 232 in its major axis direction, the part of the disk part 232 can be reduced in rigidity. This enables the part of the disk part 232 to be reduced in rigidity very easily, so that an occurrence of a contact sound can be suppressed.

### <Second Modification of Second Embodiment>

The thin portion 261 is formed in the disk part 232 in the second embodiment, and the extending portion 262 is formed in the disk part 232 in the first modification. Then, the thin portion 261 or the extending portion 262 is formed to cause a part of the disk part 232 to have rigidity less than that of the other part of the disk part 232, and the vibration absorption section 26 is formed so as to include the thin portion 261 or the extending portion 262.

Instead of or in addition to the above, the disk part 232 may be made of two or more kinds of rubber material different in rigidity to form a part of the disk part 232 made of a rubber material having low rigidity and the other part of the disk part 232 made of a rubber material having high rigidity. Even in this case, forming the vibration absorption section 26 so as to include the part of the disk part 232 enables the vibration absorption section 26 to vibrate prior to the other part of the disk part 232. Thus, even when the disk part 232 is formed of two or more kinds of rubber material different in rigidity, effects similar to those of the second embodiment and the first modification thereof can be obtained.

### Third Embodiment

In the first embodiment and each modification thereof, and the second embodiment and each modification thereof, the first valve seat side plane and the first valve body side plane are parallel to each other, as well as the second valve seat side plane and the second valve body side plane are parallel to each other. As a result, the spring 15 presses the valve body 13 in a direction aligning the axis L of the first passage 111c in the first embodiment and each modification thereof. Thus, the protrusion 133 of the valve body 13 is seated on the valve seat 12 such that a contact portion of the protrusion 133 approaches to a contact portion of the valve seat 12 in parallel to allow the protrusion 133 to be seated on the contact portion of the valve seat 12. Likewise, the spring 25 presses the valve body 23 in a direction aligning the axis L of the first passage 211c in the second embodiment and each modification thereof. Thus, the protrusion 233 of the valve body 23 is seated on the valve seat 22 such that a contact portion of the protrusion 233 approaches to a contact portion of the valve seat 22 in parallel to allow the protrusion 233 to be seated on the contact portion of the valve seat 22.

Instead of allowing the first valve seat side plane and the first valve body side plane to be parallel to each other, or allowing the second valve seat side plane and the second valve body side plane to be parallel to each other, as described above, one of the first valve seat side plane (the second valve seat side plane) and the first valve body side plane (the second valve body side plane) may have an inclination with respect to the reference plane. Hereinafter, a third embodiment will be described in detail by exemplifying the second embodiment. The same parts as those of the second embodiment are denoted by the same reference numerals to eliminate description thereof.

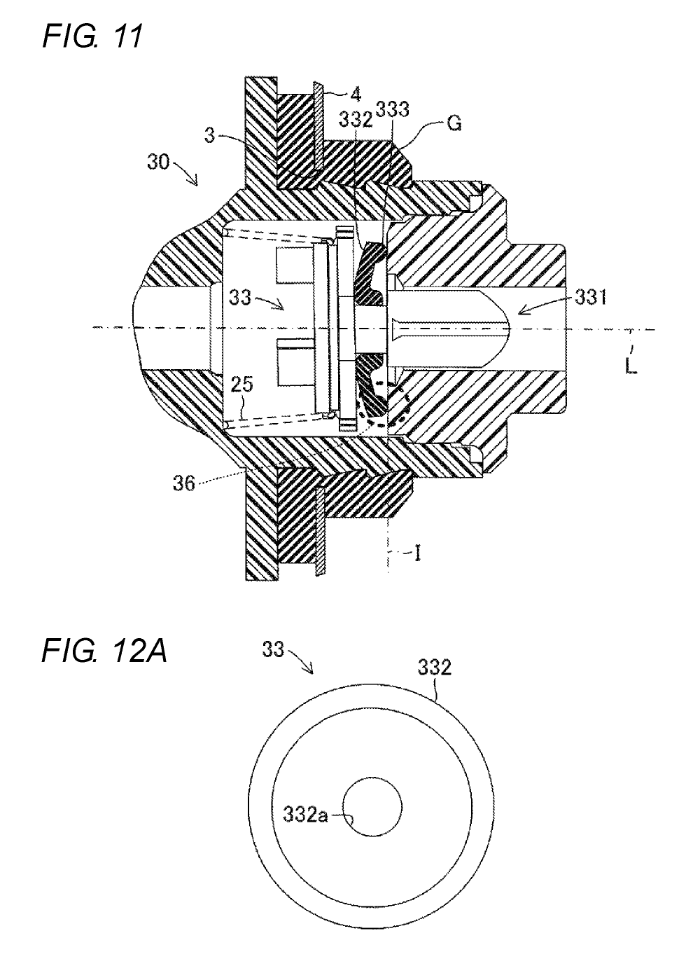

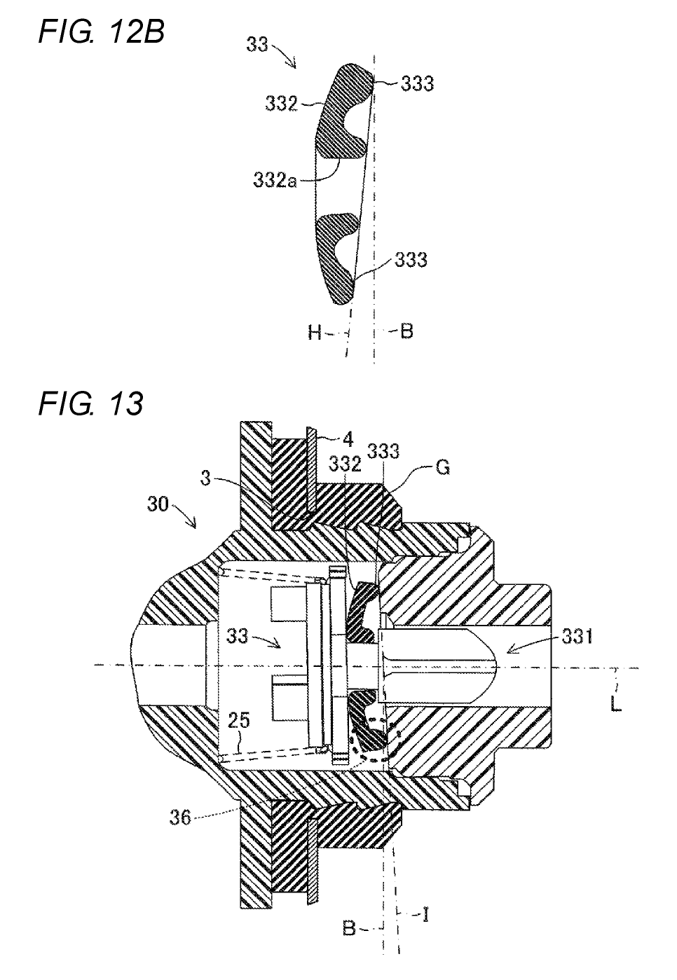

As illustrated in FIG. 11, a check valve 30 of the third embodiment is assembled such that a vacuum inlet 3 formed in a shell 4 is airtightly sealed with a grommet G. The check valve 30 is provided with a valve body 33 as illustrated in FIGS. 11, 12a, and 12b. While including a base portion 231 similarly to the valve body 23 of the second embodiment as illustrated in FIG. 11, the valve body 33 includes a disk part 332 and a protrusion 333 that are different from the disk part 232 and the protrusion 233, respectively, as illustrated in FIGS. 12a and 12b. The disk part 332 and the protrusion 333 are integrally formed of the same elastic material, or the same rubber material, for example.

As illustrated in FIG. 12a, the disk part 332 is a disk having a larger diameter than the first passage 211c of the first body part 211, and is provided in its central portion with a through hole 332a into which the neck portion 231c of the base portion 231 is airtightly inserted. In addition, the disk part 332 is formed in an umbrella shape with an apex at a forming position of the through hole 332a, and is provided in its outer peripheral portion integrally with the protrusion 333, as illustrated in FIG. 12b. The protrusion 333 is formed so as to protrude to face the valve seat 22 while being accommodated in the second body part 212, and is configured to be brought into contact with the valve seat 22 in a seated state where the valve body 33 is seated on the valve seat 22. The protrusion 333 is configured to form a contact surface with the valve seat 22 to airtightly seal between the valve body 23 and the valve seat 22 in the seated state of the valve body 23. The protrusion 333 is also configured such that its protruding length from an outer peripheral portion of the disk portion 332 continuously varies in its circumferential direction.

As illustrated in FIG. 12b, the protrusion 333 is a contact portion forming a circumferential contact surface, coming into contact with the valve seat 22, in the seated state where the valve body 33 is seated on the valve seat 22, and a plane H including a contact portion (or a tip portion of the protrusion 333 in its seating direction) before seating (hereinafter this plane H is referred to as a “third valve body side plane H”) and a reference plane B orthogonal to the axis L of the first passage 211c form a dihedral angle other than zero. Thus, the third valve body side plane H and the reference plane B are not parallel to each other in the third embodiment.

Meanwhile, in the third embodiment, the valve seat 22 is formed so as to have a third valve seat side plane I like the second valve seat side plane in the second embodiment, as illustrated in FIG. 11. That is, the third valve seat side plane I and the reference plane B are parallel (or coincident). The third valve body side plane H and the third valve seat side plane I have a dihedral angle other than zero, and thus are not parallel. As a result, the spring 25 presses the valve body 33 in a direction aligning the axis L of the first passage 211c with an urging force uniform circumferentially. Then, the protrusion 333 of the valve body 33 is seated on the valve seat 22 such that a contact portion of the protrusion 333 approaches to a contact portion of the valve seat 12 in an inclined manner to allow the protrusion 333 to be seated on the contact portion of the valve seat 22.

The spring 25 presses the valve body 33 in the direction aligning the axis L of the first passage 211c by applying an urging force uniform circumferentially. Thus, when the contact portion of the protrusion 333 is in contact with the contact portion of the valve seat 22 (or in the seated state of the valve body 33), there is a circumferential difference in pressing force pressing the valve seat 22 in the disk part 332 and the protrusion 333, pressed by the spring 25. Specifically, in the circumferential direction of each of the disk part 332 and the protrusion 333, the pressing force in a portion of the protrusion 333 with a long protruding length relatively increases, and the pressing force in a portion of the protrusion 333 with a short protruding length relatively decreases.

As described above, when the third valve body side plane H and the third valve seat side plane I are not parallel to each other, there is a circumferential difference in pressing force in the valve body 33 that is pressed by the spring 25 in the direction aligning the axis L of the first passage 211c with a pressing force uniform circumferentially, more specifically in the disk part 332 and the protrusion 333. Then, a portion of the disk portion 332 with a relatively small pressing force is more likely to move in the direction of the axis L of the first passage 211c than a portion thereof with a relatively large pressing force, and thus is likely to cause vibration due to vacuum pulsation. That is, when there is a difference in pressing force pressing the disk portion 332 circumferentially, the disk portion 332 includes a portion pressed with a small pressing force (“corresponding to a part of the disk portion” in each of the above embodiments), and a portion pressed with a large pressing force (“corresponding to the other part of the disk portion” in each of the above embodiments).

Thus, the reference plane B and the third valve body side plane H are configured with respect to the reference plane B in the third embodiment such that the reference plane B is not parallel to the third valve body side plane H, and the reference plane B is parallel to the third valve seat side plane I. This enables the vibration absorption section 36 to be formed in a part of the valve body 33 in which a pressing force generated circumferentially in the valve body 33 pressed in the direction of the axis L of the first passage 211c by the spring 25 in the seating state decreases less than the other part of the valve body 33.

Accordingly, when the third valve body side plane H has an inclination with respect to the reference plane B, a portion with a relatively small pressing force can be formed in the valve body 33. Then, the vibration absorption section 36 can be formed in a portion where the pressing force of the valve body 33 relatively decreases. The part with a relatively small pressing force is more likely to vibrate than the other part with a relatively large pressing force. Thus, when the valve body 33 vibrates due to vacuum pulsation occurring in the first passage 211c, the accommodation section 212a, and the second passage 212b, in the seated state of the valve body 33, the vibration absorption section 36 formed in the part of the valve body 33 (specifically, the disk portion 332) can absorb more vibration caused by the vacuum pulsation than the other part of the valve body 33 (specifically, the disk portion 332). This enables vibration of the entire valve body 33 to be suppressed. Thus, even when the valve body 33 is repeatedly seated on and separated from the valve seat 22 due to vibration of the valve body 33 caused by vacuum pulsation, vibration of the entire valve body 33 is suppressed, thereby enabling reduction in a contact sound caused by when the valve body 33 (specifically, the protrusion 333) is brought into contact with the valve seat 22.

In addition, the vibration absorption section 36 suppresses vibration of the entire valve body 33, so that vibration to be transmitted from the valve body 33 to the spring 25 can also be reduced. This enables bending of the spring 25 to be reduced, so that resonance of the valve body 33 and the spring 25 can be suppressed. As a result, vibration of the valve body 33 due to the resonance with the spring 25 can be suppressed to enable reducing a contact sound generated when the valve body 33 (specifically, the protrusion 333) is brought into contact with the valve seat 22.

### <First Modification of Third Embodiment>

In the third embodiment, the third valve body side plane H is not parallel to the reference plane B, and the third valve seat side plane I is parallel to the reference plane B. Instead of this, the third valve body side plane H may be parallel to the reference plane B while having an angle with respect to the axial direction of the first passage 211c to allow the third valve seat side plane I not to be parallel to the reference plane B.

As illustrated in FIG. 13, when the protrusion 333 of the valve body 33 has an uniform protruding length circumferentially, the third valve body side plane H is parallel (coincident) to the reference plane B. Meanwhile, when a distal end surface of the projecting portion 211a constituting the first body part 211, forming the valve seat 22, has an angle with respect to the axial direction of the first passage 211c, the third valve seat side plane I including a contact portion in the valve seat 22 is not parallel to the reference plane B. As a result, the third valve body side plane H and the third valve seat side plane I have a dihedral angle other than zero, and thus are not parallel.

Thus, even when the reference plane B and the third valve body side plane H are parallel to each other and the reference plane B and the third valve seat side plane I are not parallel to each other, a portion with a relatively small pressing force can be formed in the valve body 33. Then, the vibration absorption section 36 can be formed in the portion where the pressing force of the valve body 33 relatively decreases. This suppresses vibration of the entire valve body 33 even when the valve body 33 is repeatedly seated on and separated from the valve seat 22 due to vibration of the valve body 33 caused by vacuum pulsation, as in the third embodiment. Thus, this enables reducing a contact sound generated when the valve body 33 (specifically, the protrusion 333) is brought into contact with the valve seat 22.

While an aspect applied to the second embodiment is described in the third embodiment, the aspect is also applicable to the first embodiment. Even in this case, when the third valve body side plane H and the third valve seat side plane I are each inclined, a pressing force of a part of the valve body 33 (valve body 13) relatively decreases. Thus, when the vibration absorption section 36 is formed in the part of the valve body 33 (valve body 13) with a small pressing force, an effect equivalent to that of each of the third embodiment and the modification thereof can be obtained.

### Fourth Embodiment

In the first embodiment and each of the modifications thereof, the second embodiment and each of the modifications thereof, and the third embodiment and the first modification thereof, the vibration absorption sections 16, 26, and 36 are each formed so as to absorb more vibration applied to the corresponding one of the valve disks 13, 23, and 33 in a part of the corresponding one of the valve body 13, 23 and 33 than in the other part of the corresponding one of the valve bodies 13, 23, and 33. In this case, instead of or in addition to forming the vibration absorption sections 16, 26, and 36 in the valve bodies 13, 23, and 33, respectively, a vibration absorption section 46 may be formed in a grommet G of an elastic member that extends outward in a radial direction of a vacuum inlet 3 and has a circumferential protrusion covering the vacuum inlet 3 circumferentially. Hereinafter, a fourth embodiment will be described in detail.

In the description of the fourth embodiment, the check valve 20 described in the second embodiment is used and the same parts as those of the second embodiment are denoted by the same reference numerals to eliminate description thereof. It is needless to say that the vibration absorption section 46 can also be provided in the grommet G in each of the embodiments and modifications other than the second embodiment.

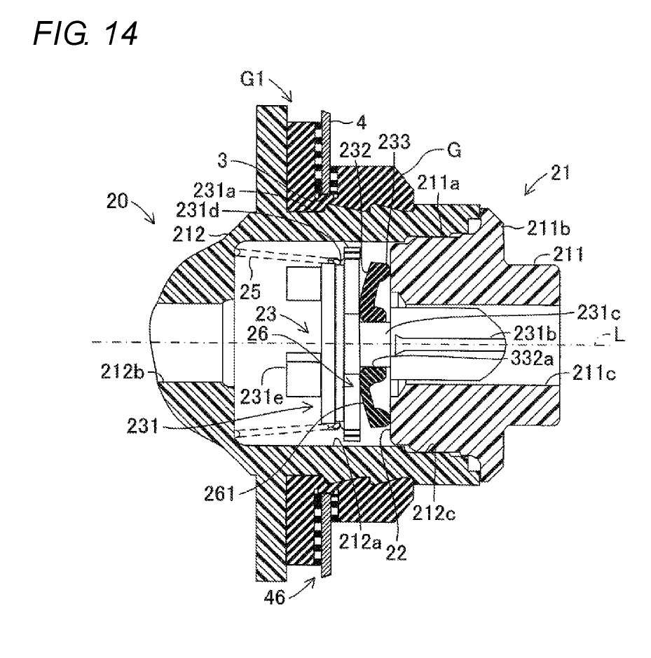

As illustrated in FIG. 14, the grommet G of the fourth embodiment is airtightly provided between the first body part 211 with the second body part 212, and the vacuum inlet 3, and is provided with the vibration absorption section 46. The grommet G absorbs more vibration applied to the valve body 23 in a seated state where the valve body 23 is seated on the valve seat 22. The grommet G includes a flange portion G1.

The flange portion G1 is formed as a circumferential protrusion that extends outward in the radial direction of the vacuum inlet 3 to cover the vacuum inlet 3 circumferentially. The flange portion G1 holds a shell 4, and is provided with the vibration absorption section 46. Thus, in the fourth embodiment, the check valve 20 is provided with the vibration absorption section 46 formed on the flange portion G1 facing the shell 4 around the vacuum inlet 3.

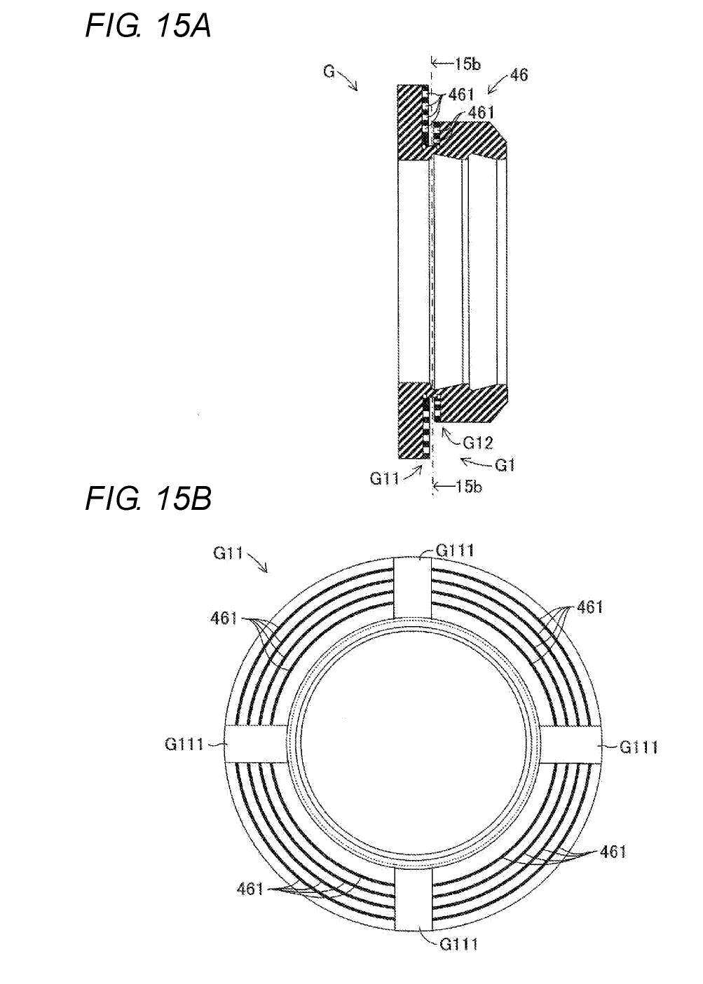

As illustrated in FIGS. 15a and 15b, the vibration absorption section 46 is formed in a part of two peripheral surfaces G 11 and G 12 that faces and sandwiches the shell 4 in the flange portion G1. The vibration absorption section 46 absorbs vibration transmitted to the shell 4 from the valve body 23 via the first body part 211 and the second body part 212 more than the other part of the flange portion G1, thereby suppressing vibration of the shell 4 and the valve body 23. While a section taken along line 15b-15b in FIG. 15a, or the vibration absorption section 46 formed on the peripheral surface G 11, will be described, for example, in the following description, the vibration absorption section 46 formed on the peripheral surface G12 also has the same structure.

The vibration absorption section 46 includes grooves 461 formed on the peripheral surface G 11 of the flange portion G1 along the circumferential direction of the vacuum inlet 3. As illustrated in FIGS. 15a and 15b, the grooves 461 are formed in a part of the peripheral surface G 11 of the flange portion G1, specifically, between adjacent close-contact portions G111 with the shell 4, formed at intervals in the circumferential direction (close-contact portions G112 in the peripheral surface G12). The grooves 461 each are formed so as to open toward the shell 4, and have a cross-sectional shape of a rectangular shape. The grooves 461 each may be formed so as to have a cross-sectional shape of a V-shape as with the groove 161 of the first embodiment.

The flange portion G1 provided with the grooves 461 as described above includes a part with the grooves 461 (hereinafter referred to as “a part of the flange portion G1”), and the close-contact portions G111 (close-contact portions G112) without the grooves 461, or the other part of the flange portion G1, which are different in rigidity. Specifically, the part of the flange portion G1 has rigidity smaller (softer) than that of the other part of the flange portion G1 (the close-contact portion G111 and the close-contact portion G112). While four grooves 461 are formed in the peripheral surface G11, and two grooves 461 are formed in the peripheral surface G12, in the fourth embodiment, the number of grooves 461 is not limited to this, and it is needless to say that the number of grooves 461 can be increased or reduced as necessary.

When a part of the flange portion G1 has low rigidity, the part of the flange portion G1 easily vibrates. Thus, when the valve body 13 vibrates in a seated state of the valve body 13 to cause not only the shell 4 but also the flange portion G1 to vibrate, the part of the flange portion G1 vibrates in priority to (prior to) the other part of the flange portion G1. When the part of the flange portion G1 vibrates in priority to (prior to) the other part of the flange portion G1 as described above, vibration energy of the shell 4 can be consumed. This enables reducing an abnormal sound generated by resonance of vibration inside the shell 4. In addition, vibration energy of the first body part 211 and the second body part 212 is consumed by transmitting the vibration to the shell 4, so that vibration energy given from air to the valve body 13 can be consumed. This enables vibration of the valve body 13 to be suppressed. Thus, even the fourth embodiment enables an effect similar to that of each of the embodiments and modifications to be obtained.

### <First Modification of Fourth Embodiment>

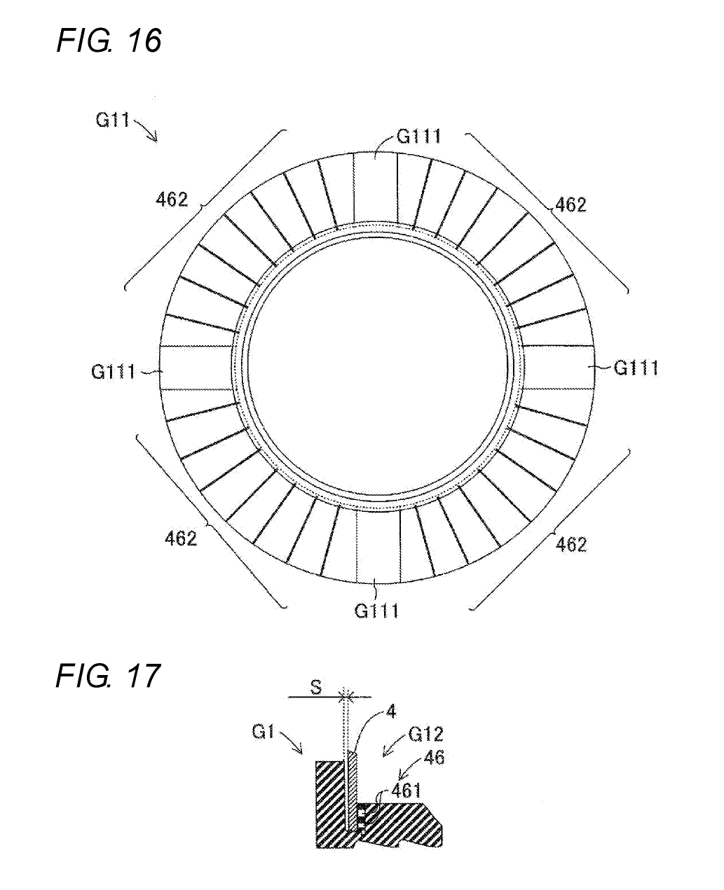

In the fourth embodiment, the grooves 461 are formed along the circumferential direction of the peripheral surface G11 and the peripheral surface G12 of the flange portion G1. In this case, instead of or in addition to forming the grooves 461 along the circumferential direction of the peripheral surface G11 and the peripheral surface G12, grooves 462 extending in the radial direction of the vacuum inlet 3 also may be formed in the peripheral surface G11 and the peripheral surface G12 of the flange portion G1 as illustrated in FIG. 16. Thus, the vibration absorption section 46 in the first modification includes the grooves 462 formed radially in a part of the peripheral surface G11 and the peripheral surface G12 of the flange portion G1. While a section taken along line 15b-15b in FIG. 15a, or the vibration absorption section 46 formed on the peripheral surface G11, will be described, for example, also in the first modification as in the fourth embodiment, the vibration absorption section 46 formed on the peripheral surface G12 also has the same structure.

As illustrated in FIG. 16, the grooves 462 are each formed radially in a part of the flange portion G1. The grooves 462 each are formed so as to open toward the shell 4, and have a cross-sectional shape of a rectangular shape. The grooves each may be formed so as to have a cross-sectional shape of a V-shape as with the groove 162 of the first modification of the first embodiment. In the flange portion G1 in which the grooves 462 are formed radially as described above, rigidity of a part of the flange portion G1 with the grooves 462 is different from that of the other part of the flange portion G1 without the grooves 462. Specifically, the part of the flange portion G1 has rigidity smaller (softer) than that of the other part of the flange portion G1. Accordingly even when the grooves 462 are formed radially in the flange portion G1 and the vibration absorption section 46 is formed so as to include the grooves 462, the part of the flange portion G1 can be reduced in rigidity very easily. Thus, even the first modification enables an effect similar to that of the fourth embodiment to be obtained.

### <Another Modification of Fourth Embodiment>

In the fourth embodiment and the first modification thereof, the grooves 461 or the grooves 462 of the vibration absorption section 46 are formed on both the peripheral surfaces G11 and G12 of the flange portion G1. In this case, the grooves 461 or the grooves 462 of the vibration absorption section 46 may be also formed on one of the peripheral surfaces G11 and G12 (the peripheral surface G12 in FIG. 17) of the flange portion G1, as illustrated in FIG. 17. In this case, when a gap is formed between the other of the peripheral surfaces G11 and G12 (the peripheral surface G11 in FIG. 17) of the flange portion G1 and the shell 4 as illustrated in FIG. 17, a part of the flange portion G1, being provided with the grooves 461 or the grooves 462, can be easily vibrated. Thus, even this case enables an effect similar to that of each of the fourth embodiment and the first modification thereof to be obtained.

The present invention is not limited to the embodiments above and each of the modifications above, and thus various modifications can be adopted within the scope of the present invention.

For example, the grooves 161 described in the first embodiment can be formed in the disk part 232 of the valve body 23 described in the second embodiment. In addition, the thin portion 261 or the extending portion 262 described in the second embodiment also can be formed in the disk portion 132 of the valve disk 13 described in the first embodiment. Even a combination of them enables an effect equivalent to that of each of the embodiments and modifications to be obtained.

In the first embodiment and the first modification of the first embodiment, the grooves 161 and 162 are each formed so as to open toward the spring 15. In this case, the grooves 161 and 162 may be formed so as to open toward the valve seat 12. Even this case enables an effect equivalent to that of each of the first embodiment and the first modification of the first embodiment to be obtained.

In each of the embodiments and modifications above, each of the check valves 10, 20, and 30 is assembled to the vacuum inlet 3 formed in the shell 4 of the vacuum booster 2 using the grommet G. In this case, when the shell 4 of the vacuum booster 2 is made of resin, each of the first body parts 111 and 211 can be integrally formed with the shell 4, for example. Accordingly, operation of fixing each of the first body parts 111 and 211 to the shell 4 is unnecessary, so that manufacturing costs can be reduced.

In each of the embodiments and modifications above, each of the check valves 10, 20, and 30 is directly assembled to the vacuum booster 2. In this case, each of the check valves 10, 20, and 30 may be assembled inside of the connection pipe T or in an intermediate portion of the connection pipe T, for example. Accordingly, there is no need to secure a space for installing each of the check valves 10, 20, and 30 around the vacuum booster 2, so that a degree of freedom of placing the vacuum booster 2 can be secured.

1. A vacuum booster check valve provided between a vacuum booster having a vacuum inlet connected to a vacuum source and the vacuum source to block a flow of air from the vacuum source toward the vacuum inlet while allowing a flow of air from the vacuum inlet toward the vacuum source, the vacuum booster check valve comprising:
a main body provided so as to be connected to a vacuum inlet;
a passage formed in the main body to allow the vacuum inlet to communicate with the vacuum source;
a valve seat formed in the passage;
a valve body having a base portion in a cylindrical shape extending toward inside the passage in an axial direction of the passage while being accommodated in the passage to be seated on or separated from the valve seat, a disk portion extending in a radial direction of the base portion, and a protrusion in an annular shape protruding from an outer peripheral portion of the disk portion toward the valve seat;
an urging member accommodated in the passage to urge the valve body toward the valve seat so as to bring the protrusion into contact with the valve seat; and
a vibration absorption section that absorbs more vibration applied to the valve body in a seated state where the valve body is seated on the valve seat.

2. The vacuum booster check valve according to claim 1, wherein
the vibration absorption section absorbs vibration applied to the valve body more in a part of the valve body than in another part of the valve body in a seated state where the valve body is seated on the valve seat.

3. The vacuum booster check valve according to claim 2, wherein
the valve body includes at least the disk portion and the protrusion that are each formed of an elastic material,
the vibration absorption section is formed in a part of the disk portion of the valve body, and
the part of the disk portion has less rigidity than rigidity of another part of the disk portion of the valve body.

4. The vacuum booster check valve according to claim 3, wherein
the part of the disk portion includes a groove formed in the disk portion at least in one direction of a circumferential direction of the disk portion and a radial direction of the disk portion so as to open toward the urging member or the valve seat.

5. The vacuum booster check valve according to claim 3, wherein
the part of the disk portion and the other part of the disk portion are each formed of an identical elastic material, and
the part of the disk portion has a smaller thickness than a thickness of the other part of the disk portion.

6. The vacuum booster check valve according to claim 3, wherein
the disk portion has a major axis and a minor axis, and
the part of the disk portion includes an extending portion formed in a direction of the major axis of the disk portion.

7. The vacuum booster check valve according to claim 2, wherein
a contact portion of the protrusion forms a circumferential contact surface with the valve seat in the seated state, a valve body side plane including the contact portion of the protrusion in a state where the valve body is separated from the valve seat,
a contact portion of the valve seat forms a circumferential contact surface with the valve body in the seated state, a valve seat side plane including the contact portion of the valve seat in a state where the valve body is separated from the valve seat,
a reference plane is orthogonal to an axial direction of the passage,
the reference plane and the valve body side plane are not parallel to each other, and the reference plane and the valve seat side plane are parallel to each other, or
the reference plane and the valve body side plane are parallel to each other, and the reference plane and the valve seat side plane are not parallel to each other, and
the vibration absorption section is formed in a part of the valve body where a pressing force generated in a circumferential direction of the valve body pressed by the urging member in the axial direction of the passage in the seated state is decreased more than another part of the valve body.

8. The vacuum booster check valve according to claim 1, wherein
an elastic member is airtightly provided between the main body and the vacuum inlet, and
the vibration absorption section absorbs more vibration applied to the valve body with the elastic member in the seated state where the valve body is seated on the valve seat.

9. The vacuum booster check valve according to claim 8, wherein
the elastic member has a protrusion in a circumferential shape that extends outward in a radial direction of the vacuum inlet and covers the vacuum inlet circumferentially, and
the vibration absorption section is formed in the protrusion.

10. The vacuum booster check valve according to claim 9, wherein
the vibration absorption section includes a groove formed in a peripheral surface, facing the vacuum inlet, of the protrusion in a circumferential shape, the groove extending in a circumferential direction or the radial direction of the vacuum inlet.
